(19) United States
(12) Patent Application Publication
(10) Pub. No.: US 2008/0125526 A1
(43) Pub. Date: May 29, 2008

(54) Flameproof Styrenic Resin Composition

(75) Inventors: Su Hak BAE, Seoul (KR); Sang Hyun HONG, Seoul (KR); Jeong Hwan KU, Gunpo-si (KR); Jae Ho YANG, Gunpo-si (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 11/769,921

(22) Filed: Jun. 28, 2007

Related U.S. Application Data
(63) Continuation-in-part of application No. PCT/KR05/02236, filed on Jul. 12, 2005.

(30) Foreign Application Priority Data
Dec. 30, 2004 (KR) 10-2004-0116820

(51) Int. Cl. C08K 5/521

(52) U.S. Cl. 524/127

(57) ABSTRACT

Disclosed herein is a styrenic resin composition comprising (A) about 15 to about 80 parts by weight of a styrenic resin, (B) about 15 to about 80 parts by weight of a polyphenylene ether resin, and (C) about 0.1 to about 25 parts by weight of a phosphoric compound comprising (c₁) about 1 to about 30% by weight of an alkyl phosphinic metal salt and (c₂) about 70 to about 99% by weight of an aromatic phosphate ester, per 100 parts by weight of a base resin comprising (A) and (B).

### CROSS REFERENCE TO RELATED APPLICATIONS

This non-provisional application is a continuation-in-part application of PCT Application No. PCT/KR2005/002236, filed Jul. 12, 2005, pending, which designates the U.S. and which is hereby incorporated by reference in its entirety, and also claims priority from Korean Patent Application No. 10-2004-0116820, filed Dec. 30, 2004, which is also hereby incorporated by reference in its entirety.

### FIELD OF THE INVENTION

The present invention relates to a flameproof styrenic composition.

### BACKGROUND OF THE INVENTION

Styrenic resins can have excellent mold processability and mechanical properties and have accordingly been widely used in the production of many electric or electronic goods. However, styrenic resins can readily catch on fire. Accordingly, styrenic resins are subject to various mandatory controls on flammability for safety reasons in the United States, Japan and Europe and are required to have high flame retardancy to meet the Underwriter's Laboratories Standard for use in the housing of electric appliances.

A halogen-containing compound and an antimony-containing compound can be added to a rubber modified styrene-containing resin to impart good flame-retardant properties to the resin. Examples of halogen-containing compounds used to impart flame retardancy include, for example, polybromodiphenyl ether, tetrabromobisphenol-A, epoxy compounds substituted by bromine, chlorinated polyethylene, and the like. Antimony trioxide or antimony pentaoxide is commonly used as an antimony-containing compound.

Methods for improving the flame-retardant properties of resins using a halogen- and antimony-containing compound can be advantageous because these compounds can readily impart a desired degree of flame-retardancy to the product and further may not significantly degrade physical properties. However, hydrogen halide gases released by halogen-containing compounds during molding processes can corrode the mold. Further, such compounds can emit toxic gases if ignited. Polybromodiphenyl ether, which is widely used as a halogen-containing flame retardant, can produce toxic gases such as dioxin or furan during combustion, and thus a major concern in this field is to develop a flame retardant that does not include a halogen-containing compound.

Generally, when a rubber modified styrene-containing resin is burned, the desired flame retardancy in a solid state cannot be achieved (Journal of Applied Polymer Science, 1998, vol. 68, p. 1067). Therefore, to impart flame retardancy to a rubber modified styrene-containing resin, it can be necessary to add a char-forming agent to a resin composition, which plays a role in forming the char.

U.S. Pat. No. 3,639,506 is directed to a resin composition that acquires flame retardancy by adding a triphenyl phosphate (TPP), an aromatic phosphoric acid ester, to a polyphenylene ether resin and a styrenic resin. However, the addition of TPP reduces the heat-resistancet property of the resin composition, and accordingly a halogen-containing compound is employed to prevent this drop.

U.S. Pat. No. 3,883,613 is directed to a resin composition that acquires flame retardancy by adding a trimesityl phosphate as a flame retardant to a polyphenylene ether resin and a styrenic resin. U.S. Pat. No. 4,526,917 is directed to a resin composition wherein its flame retardancy is improved by using TPP and a trimesityl phosphate together as compared the use of either of these compounds singly. However, since this aromatic phosphoric acid ester has an amount of a phosphor below 10 percent, the resin composition should be used in large amounts.

U.S. Pat. No. 6,547,992 is directed to a flame retardant combination for thermoplastic polymers comprising an alkyl phosphinic acid metal salt compound and optionally melamine phosphate or metal hydrates. However, the combination of styrenic resin and alkyl phosphinic acid metal salt does not show sufficient flame retardancy.

### SUMMARY OF THE INVENTION

To solve these problems including environmental problems and fire stability, the present inventors have developed a flame retardant styrenic resin composition which has good flame retardancy and heat resistance. The flame retardant styrenic composition of the invention can be prepared by adding an alkyl phosphinic acid metal salt compound and an aromatic phosphoric ester compound to a base resin including a styrenic resin and a polyphenylene ether resin. The resultant thermoplastic resin composition can exhibit fire stability, can be environmentally friendly with no halogen-containing flame retardant which can cause environmental pollution during preparation or combustion of the resin, and further can exhibit good heat resistance, mechanical strength and flowability stability useful for the manufacture of housings for electric or electronic appliances.

A flameproof styrenic resin composition in accordance with the present invention can include:
(A) about 15 to about 80 parts by weight of a styrenic resin;
(B) about 15 to about 80 parts by weight of a polyphenylene ether resin; and
(C) about 0.1 to about 25 parts by weight of a phosphoric compound comprising (c₁) about 1 to about 30% by weight of an alkyl phosphinic acid metal salt and (c₂) about 70 to about 99% by weight of an aromatic phosphate ester, per 100 parts by weight of a base resin comprising (A) and (B).

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

### (A) Styrenic Resin

The styrenic resin used in the present invention can be prepared by blending a rubber, an aromatic mono-alkenyl monomer and/or alkyl ester monomer and optionally an unsaturated nitrile monomer and polymerizing with heat or a polymerization initiator.

Rubbers useful in this invention can include without limitation polybutadiene, polyisoprenes, styrene-butadiene copolymers, alkylacrylic rubbers, and the like, and mixtures thereof. The amount of rubber used can be about 3 to about 30% by weight, for example, about 5 to about 15% by weight, per 100% by weight of the styrenic resin.

Monomers useful in the styrenic resin can include one or more monomers selected from the group consisting of aromatic mono-alkenyl monomers and/or alkyl ester monomers, and can be used in an amount of about 70 to about 97% by weight, for example, about 85 to about 90% by weight. About 0 to about 5% by weight of an unsaturated nitrile monomer can be added and then copolymerization can be conducted. Acrylic acid, methacrylic acid, maleic anhydride, N-substituted maleimide and the like, and mixtures thereof can also be added and polymerized to impart processability and heat resistance to the polymer. These can be added in an amount of about 0 to about 40 parts by weight.

The resin composition of the present invention can be polymerized with heat and with no polymerization initiator, although a polymerization initiator can optionally be also used. Polymerization initiators useful in the present invention may include one or more selected from the group consisting of organic peroxides such as benzoyl peroxide, t-butyl hydroperoxide, acetyl peroxide and cumene hydroperoxide or azo compounds such as azobisisobutyronitrile, and the like, and mixtures thereof.

The styrenic resin of the present invention can be produced using known polymerization methods, such as bulk polymerization, suspension polymerization, emulsion polymerization, or a combination thereof.

The average size of rubber particles can range from about 0.1 to about 2.0 μm to optimize physical properties when blending a styrenic resin and a polyphenylene ether.

The styrenic resin (A) of the present invention can be used in an amount of about 15 to about 80 by weight, for example, about 25 to about 80 by weight.

### (B) Polyphenylene Ether (PPE)

Since the styrenic resin (A) is not enough to improve flame retardancy and heat resistance, a polyphenylene ether (B) is employed with the styrenic resin (A) as a part of the base resin.

Examples of suitable polyphenylene ether resins can include without limitation poly(2,6-dimethyl-1,4-phenylene) ether, poly(2,6-diethyl-1,4-phenylene) ether, poly(2,6-dipropyl-1,4-phenylene) ether, poly(2-methyl-6-ethyl-1,4-phenylene) ether, poly(2-methyl-6-propyl-1,4-phenylene) ether, poly(2-ethyl-6-propyl-1,4-phenylene) ether, poly(2,6-diphenyl-1,4-phenylene) ether, copolymer of poly(2,6-dimethyl-1,4-phenylene) ether and poly(2,3,6-trimethyl-1,4-phenylene) ether, and copolymer of poly(2,6-dimethyl-1,4-pheylene) ether and poly(2,3,5-triethyl-1,4-phenylene) ether, and the like, and mixtures thereof.

The degree of polymerization of the polyphenylene ether (B) is not limited specifically, but can vary depending on factors such as heat-stability or processability of the resin composition. The intrinsic viscosity of the polypheylene ether can be in the range of about 0.2 to about 0.8 measured in chloroform solvent at 25° C.

The polyphenylene ether (B) of the present invention can be used in an amount of about 15 to about 80 parts by weight, for example about 20 to about 75 parts by weight. Using less than about 15 parts by weight can deteriorate impact strength and flame retardancy.

### (C) Phosphoric Compound

(c₁) Alkyl Phosphinic Acid Metal Salt

The alkyl phosphinic acid metal salt can be represented by the following structural formula (I):

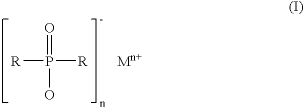

wherein R is C₁₋₆ alkyl, cyclic alkyl, or C₆₋₁₀ aryl, M is a metal such as Al, Zn and Ca, and n is an integer of 2 or 3.

R can be, for example, methyl, ethyl, propyl, butyl or phenyl and M can be Al or Zn.

The alkyl phosphinic acid metal salt (c₁) can have a particle size of below about 10 μm. If the particle size of the alkyl phosphinic acid metal salt is more than about 10 μm, impact strength and flame retardancy can deteriorate. If the particle size of the alkyl phosphinic acid metal salt is less than about 0.01 μm, it can be difficult to prepare the composition and the processability of extrusion becomes poor.

(c₂) Aromatic Phosphate Ester Compound

The aromatic phosphate ester compound used in the present invention can be a compound having the following structural formula (II):

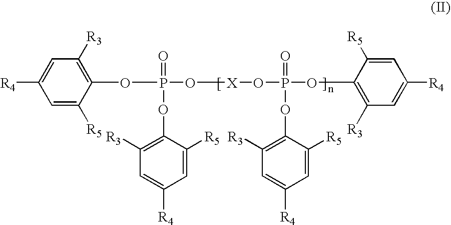

wherein R₃, R₄ and R₅ are each independently of one another hydrogen or C₁-C₄ alkyl; X comprises C₆-C₂₀ aryl or alkyl-substituted C₆-C₂₀ aryl group for example, a derivative from a dialcohol such as resorcinol, hydroquinol, bisphenol-A and the like; and n is 0 to 4.

Where n is 0, the compound represented in the structural formula (II) includes triphenyl phosphate, tri(2,6-dimethyl) phosphate, and the like, and where n is 1, the compounds include resorcinolbis(diphenyl) phosphate, resorcinolbis(2,6-dimethyl phenyl) phosphate, resorcinolbis(2,4-ditertiary butyl phenyl) phosphate, hydroquinolbis (2,6-dimethyl phenyl) phosphate, hydroquinolbis(2,4-ditertiary butyl phenyl) phosphate, and the like. The aromatic phosphate ester (c₂) compounds can be used alone or in combination therewith.

In the present invention, the ratio of the alkyl phosphinic acid metal salt (c₁) and the aromatic phosphate ester (c₂) can be in the range of about 1/99 to about 30/70 in order to improve flame retardancy, impact strength and external appearance.

The phosphoric compound (C) of the present invention can be used in an amount of about 0.1 to about 25 parts by weight per 100 parts by weight of the base resin (A)+(B). Using less than about 0.1 parts by weight of the phosphoric compound (C) may not provide flame retardancy. Using more than about 25 parts by weight of the phosphoric compound (C) may deteriorate impact strength, heat resistance and the like.

The flame retardant resin composition of the present invention may further contain conventional additives, for example, plasticizers, heat stabilizers, anti-oxidants, compatibilizers, light stabilizers, pigment, dye and/or inorganic filler. The inorganic filler can be asbestos, glass fiber, talc, ceramic and sulfonate etc. The additives can be used in an amount of about 0 to about 30 parts by weight, based on the entire weight of the resin composition.

The present invention may be better understood by reference to the following examples that are intended for the purpose of illustration and are not to be construed as in any way limiting the scope of the present invention, which is defined in the claims appended hereto.

### EXAMPLES

The components to prepare flameproof thermoplastic resin compositions in Examples and Comparative Examples are as follows:

### (A) Styrenic Resin

The styrenic resin of Cheil Industries Inc. (Product name: HG-1760S) is used. The particle size of butadiene rubber is 1.5 μm and the rubber content is 6.5% by weight.

### (B) Polyphenylene Ether Resin (PPE)

A poly(2,6-dimethyl-phenylether) by Asahi Kasehi Co. of Japan (Product name: S-202) is used. The particles have an average size of several dozens of microns (μm) and are in the form of powder.

### (C) Phosphoric Compound

(c₁) Alkyl Phosphinic Acid Metal Salt

(c₁₁) A diethyl phosphinic acid aluminum salt by Clariant Co. (Product name: Exolit OP930) is used. The average particle size is 5 μm and the phosphor content is 23% by weight.

(c₁₂) A diethyl phosphinic acid aluminum salt by Clariant Co. (Product name: Exolit OP1230) is used. The average particle size is 20 μm and the phosphor content is 23% by weight.

(c₂) Aromatic Phosphate Ester Compound

Bis(dimethylphenyl) phosphate bisphenol A produced by Daihachi Chemical of Japan (product name: CR741S) is used.

### Examples 1-3

The components as shown in Table 1 are mixed and the mixture is extruded at 200 to 280° C. with a conventional twin-screw extruder in pellets. The resin pellets are dried at 80° C. for 3 hours, and molded into test specimens for measuring flame retardancy using a 6 oz injection molding machine at 180 to 280° C. and mold temperature of 40 to 80° C. The flame retardancy is measured in accordance with UL94VB under a thickness of 1/10″. The notch Izod impact strength is measured in accordance with ASTM 256A under a thickness of ⅛″. The heat resistance is measured in accordance with ASTM D 1525 under 5 kgf. The spiral length, the length of resin flow, is measured using a 10 oz injection molding machine at 250° C. and mold temperature of 50° C. at the molding speed of 60% with an injection flowing measurer. The gloss is measured with a gloss measurer at the measuring angle of 60°.

### Comparative Examples 1-6

Comparative Examples 1-6 are prepared in the same manner as in Examples 1-3 except that each of compositions is used in accordance with below Table 1. The results are shown in Table 1.

TABLE 1

| | | | Examples | | | Comparative Examples | | | | | |
|---|---|---|---|---|---|---|---|---|---|---|---|
| | | | 1 | 2 | 3 | 1 | 2 | 3 | 4 | 5 | 6 |
| (A) | | | 70 | 70 | 75 | 70 | 70 | 70 | 70 | 70 | 70 |
| (B) | | | 30 | 30 | 25 | 30 | 30 | 30 | 30 | 30 | 30 |
| (C) | (c₁) | (c₁₁) | 2 | 4 | 5 | 20 | — | — | 1 | 15 | 15 |
| | | (c₁₂) | — | — | — | — | 20 | — | — | — | — |

| | | | | | | | | | |
|---|---|---|---|---|---|---|---|---|---|
| (c₂) | 18 | 16 | 17 | — | — | 20 | 22 | 5 | 10 |

| | | | | | | | | | |
|---|---|---|---|---|---|---|---|---|---|
| UL94 Flame Retardancy ( 1/10″) | V-0 | V-0 | V-0 | V-1 | V-1 | V-1 | V-1 | V-1 | V-0 |
| Izod Impact Strength ⅛″ (kgf · cm/cm) | 12 | 12 | 11 | 7 | 3 | 11 | 10 | 7 | 5 |
| Heat Resistance (° C.) | 93 | 96 | 90 | 125 | 123 | 89 | 86 | 113 | 103 |
| Spiral Length (250° C., 60%) (cm) | 63 | 59 | 67 | 33 | 35 | 65 | 70 | 55 | 60 |
| Gloss | 92 | 90 | 88 | 85 | 60 | 91 | 90 | 85 | 84 |

As shown above, the resin compositions employing an alkyl phosphinic acid metal salt with an aromatic phosphoric ester in a specific ratio show good flame retardancy under a thickness of 1/10″, heat resistance, and impact strength as compared to those compositions employing the aromatic phosphoric ester independently. When the alkyl phosphinic acid metal salt is used alone, flame retardancy and flowability significantly deteriorates. When the average particle size over 20 μm is employed alone, impact strength and gloss are very poor.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A flameproof styrenic resin composition comprising:
(A) about 15 to about 80 parts by weight of a styrenic resin;
(B) about 15 to about 80 parts by weight of a polyphenylene ether resin; and
(C) about 0.1 to about 25 parts by weight of a phosphoric compound comprising (c₁) about 1 to about 30% by weight of an alkyl phosphinic acid metal salt and (c₂) about 70 to about 99% by weight of an aromatic phosphate ester, per 100 parts by weight of a base resin comprising (A) and (B).

2. The flameproof styrenic resin composition as defined in claim 1, wherein the polyphenylene ether (B) is poly(2,6-dimethyl-1,4-phenylene) ether.

3. The flameproof styrenic resin composition as defined in claim 1, wherein the alkyl phosphinic acid metal salt (c₁) has a particle size of below about 10 μm.

4. The flameproof styrenic resin composition as defined in claim 1, wherein the alkyl phosphinic acid metal salt (c₁) is represented by the following formula (I): 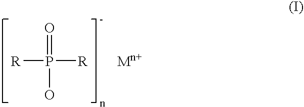
wherein R is C₁₋₆ alkyl, cyclic alkyl, or C₆₋₁₀ aryl, M is a metal, and n is an integer of 2 or 3.

5. The flameproof styrenic resin composition as defined in claim 4, wherein M comprises a metal selected from the group consisting of Al, Zn and Ca.

6. The flameproof styrenic resin composition as defined in claim 1, wherein the aromatic phosphoric acid ester (c₂) is represented by the following formula (II): 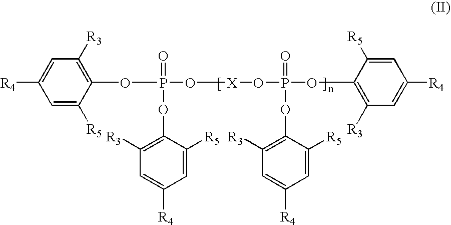
wherein R₃, R₄ and R₅ are each independently hydrogen or C₁-C₄ alkyl; X comprises C₆-C₂₀ aryl or alkyl-substituted C₆-C₂₀ aryl group that is a derivative from a dialcohol; and n is 0 to 4.

7. The flameproof styrenic resin composition as defined in claim 6, wherein X comprises C₆-C₂₀ aryl or alkyl-substituted C₆-C₂₀ aryl group that is a derivative from resorcinol, hydroquinol or bisphenol-A.

8. The flameproof styrenic resin composition as defined in claim 1, wherein the alkyl phosphinic acid metal salt (c₁) is diethyl phosphinic acid aluminum salt.

9. The flameproof styrenic resin composition as defined in claim 1, further comprising about 0 to about 30 parts by weight of at least one additive selected from the group consisting of heat stabilizers, anti-oxidants, compatibilizers, light stabilizers, pigment, dye and inorganic filler.

10. A molded article prepared with a flameproof styrenic resin composition comprising:
(A) about 15 to about 80 parts by weight of a styrenic resin;
(B) about 15 to about 80 parts by weight of a polyphenylene ether resin; and
(C) about 0.1 to about 25 parts by weight of a phosphoric compound comprising (c₁) about 1 to about 30% by weight of an alkyl phosphinic acid metal salt and (c₂) about 70 to about 99% by weight of an aromatic phosphate ester, per 100 parts by weight of a base resin comprising (A) and (B).

11. The molded article as defined in claim 10, wherein the polyphenylene ether (B) is poly(2,6-dimethyl-1,4-phenylene) ether.

12. The molded article as defined in claim 10, wherein the alkyl phosphinic acid metal salt (c₁) has a particle size of below about 10 μm.

13. The molded article as defined in claim 10, wherein the alkyl phosphinic acid metal salt (c₁) is represented by the following formula (I): 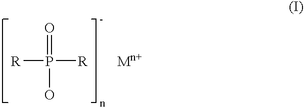
wherein R is C₁₋₆ alkyl, cyclic alkyl, or C₆₋₁₀ aryl, M is a metal, and n is an integer of 2 or 3.

14. The molded article as defined in claim 13, wherein M comprises a metal selected from the group consisting of Al, Zn and Ca.

15. The molded article as defined in claim 10, wherein the aromatic phosphoric acid ester (c₂) is represented by the following formula (II): 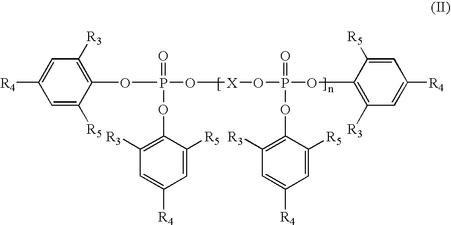
wherein R₃, R₄ and R₅ are each independently hydrogen or C₁-C₄ alkyl; X comprises C₆-C₂₀ aryl or alkyl-substituted C₆-C₂₀ aryl group that is a derivative from a dialcohol; and n is 0 to 4.

16. The molded article as defined in claim 15, wherein X comprises C₆-C₂₀ aryl or alkyl-substituted C₆-C₂₀ aryl group that is a derivative from resorcinol, hydroquinol or bisphenol-A.

17. The molded article as defined in claim 10, wherein the alkyl phosphinic acid metal salt (c₁) is diethyl phosphinic acid aluminum salt.

18. The molded article as defined in claim 10, further comprising about 0 to about 30 parts by weight of at least one additive selected from the group consisting of heat stabilizers, anti-oxidants, compatibilizers, light stabilizers, pigment, dye and inorganic filler.
